(19) United States
(12) Patent Application Publication
(10) Pub. No.: US 2012/0092960 A1
(43) Pub. Date: Apr. 19, 2012

(54) MONITORING USING DISTRIBUTED ACOUSTIC SENSING (DAS) TECHNOLOGY

(76) Inventors: GRAHAM GASTON, (US); Francis X. Bostick, III, Houston, TX (US); Brian K. Drakeley, Humble, TX (US)

(21) Appl. No.: 13/276,959

(22) Filed: Oct. 19, 2011

Related U.S. Application Data
(60) Provisional application No. 61/394,514, filed on Oct. 19, 2010.

(51) Int. Cl. G01V 1/00

(52) U.S. Cl. 367/35

(57) ABSTRACT

Methods and systems are provided for performing acoustic sensing by utilizing distributed acoustic sensing (DAS) along a length of a conduit, such that the sensing is performed with the functional equivalent of tens, hundreds, or thousands of sensors. Utilizing DAS in this manner may cut down the time in performing acoustic sensing, which, therefore, may make acoustic sensing more practical and cost effective and may enable applications that were previously cost prohibitive with discrete acoustic sensors.

### CROSS-REFERENCE TO RELATED APPLICATIONS

This application claims benefit of U.S. Provisional Patent Application Ser. No. 61/394,514, filed Oct. 19, 2010, which is herein incorporated by reference.

### BACKGROUND OF THE INVENTION

1. Field of the Invention

Embodiments of the present invention generally relate to methods and apparatus for performing acoustic sensing based on distributed acoustic sensing (DAS).

2. Description of the Related Art

Sensing of a wellbore, pipeline, or other conduit/tube (e.g., based on acoustic sensing) may be used to measure many important properties and conditions. For example, formation properties that may be important in producing from, injecting into, or storing fluids in downhole subsurface reservoirs comprise pressure, temperature, porosity, permeability, density, mineral content, electrical conductivity, and bed thickness. Further, fluid properties, such as viscosity, chemical elements, and the content of oil, water, and/or gas, may also be important measurements. Monitoring such properties and conditions, either instantaneously or by determining trends over time, may have significant value.

Acoustic sensing systems typically require an array of one or more acoustic sensors/receivers and acoustic signals that are generated either passively (e.g., seismic or microseismic activity) or by an acoustic energy source. The sensor arrays may consist of multiple discrete devices, and the deployment of an array of sensors may be complex and expensive. Therefore, deployment of the array may be time-consuming and cost-ineffective. Permanently (or semi-permanently) deployed sensors must be able to withstand the downhole environment for long periods of time. In some cases, the downhole conditions, e.g., temperatures and pressures, may be very arduous to sensor technologies.

The deployment of a multi-sensor acoustic array currently entails the use of multiple electrical conductors conveyed from the surface to the downhole sensors, sophisticated downhole electronics, or optically multiplexed discrete sensors. Optically multiplexed sensor arrays have been deployed based on fiber Bragg gratings (FBGs), for seismic imaging and monitoring and for sonar acoustic-based flowmeters.

Performing acoustic sensing utilizing the above-described array may be time consuming and cost ineffective. For example, when performing acoustic sensing in a wellbore, the array may have to be moved along different areas of the wellbore to gain coverage of the required physical locations to be sensed.

### SUMMARY OF THE INVENTION

One embodiment of the present invention is a method. The method generally includes introducing optical pulses into a fiber optic cable disposed along a length of a conduit, receiving acoustic signals that cause disturbances in the optical pulses propagating through the fiber optic cable, and performing distributed acoustic sensing (DAS) along the length of the conduit by sensing the disturbances, such that the sensing produces the functional equivalent of a plurality of sensors along the length of the conduit.

Another embodiment of the present invention is a system. The system generally includes a fiber optic cable disposed along a length of a first wellbore, an acoustic energy source disposed in a second wellbore for generating acoustic signals, and a control unit for performing DAS along the length of the first wellbore. The control unit is typically configured to introduce optical pulses into the fiber optic cable, wherein the acoustic signals cause disturbances in the optical pulses propagating through the fiber optic cable, and to perform the DAS, such that the sensing produces the functional equivalent of a plurality of sensors along the length of the first wellbore.

Another embodiment of the present invention is a system. The system generally includes a fiber optic cable disposed at a surface of a wellbore and a control unit for performing DAS at the surface of the wellbore. The control unit is typically configured to introduce optical pulses into the fiber optic cable, wherein acoustic signals cause disturbances in the optical pulses propagating through the fiber optic cable, and to perform the DAS, such that the sensing produces the functional equivalent of a plurality of sensors at the surface of the wellbore.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross-sectional view of a wellbore with an optical fiber for distributed acoustic sensing (DAS) deployed downhole, according to an embodiment of the present invention.

FIG. 2 illustrates a DAS system using an acoustic energy source and a DAS device both embedded within a cable, according to an embodiment of the present invention.

FIG. 3 illustrates a DAS system, comprising acoustic energy sources disposed at the surface of a wellbore and a DAS device suspended in the wellbore along a tubing, according to an embodiment of the present invention.

FIG. 4 illustrates a DAS system using acoustic signals generated passively, according to an embodiment of the present invention.

FIG. 5 illustrates a plan view of a wellbore that may be developed further in accordance with the detection of natural or induced subsurface fault lines using DAS, according to an embodiment of the present invention.

FIGS. 6A-D illustrate examples of surface or relatively shallow subsurface deployment geometries of a DAS device, according to an embodiment of the present invention.

FIG. 7 illustrates an embodiment of a DAS system implementing cross-well imaging, according to an embodiment of the present invention.

FIG. 8 illustrates an embodiment of a DAS system implementing the use of a DAS device as virtual source points for further receivers of subsequent direct or reflected acoustic energies, according to an embodiment of the present invention.

FIG. 9 illustrates example operations for performing DAS along a length of a conduit, according to an embodiment of the present invention.

### DETAILED DESCRIPTION

Embodiments of the present invention provide methods and apparatus for performing acoustic sensing by utilizing distributed acoustic sensing (DAS) along a length of a conduit, such that the sensing is performed with the functional equivalent of tens, hundreds, or thousands of sensors. Utilizing DAS in this manner may cut down the time in performing acoustic sensing, which, therefore, may make acoustic sensing more practical and cost effective and may enable applications that were historically cost prohibitive with discrete acoustic sensors.

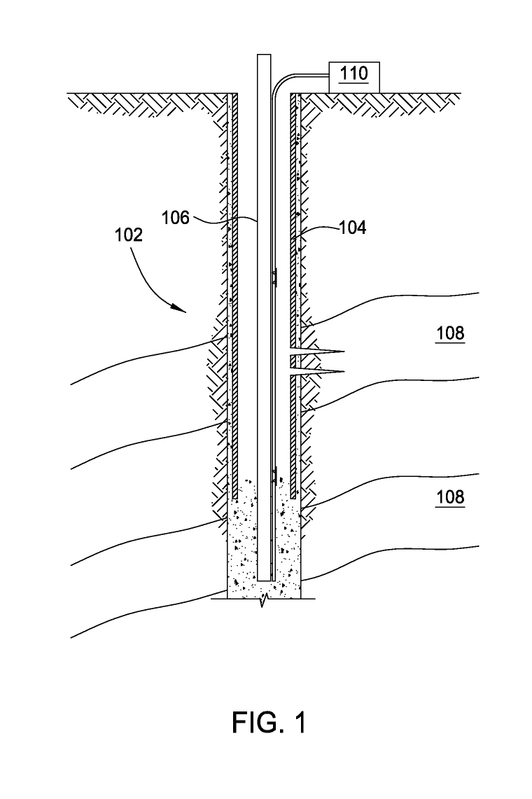

FIG. 1 illustrates a schematic cross-sectional view of a wellbore 102, wherein a DAS system 110 may be used to perform acoustic sensing. A DAS system may be capable of producing the functional equivalent of tens, hundreds, or even thousands of acoustic sensors. Properties of the wellbore 102, a wellbore completion (e.g., casing, cement, production tubing, packers), and/or downhole formations and interstitial fluid properties surrounding or otherwise adjacent the wellbore 102 may be monitored over time based on the acoustic sensing. Further, hydrocarbon production may be controlled, or reservoirs 108 may be managed, based on these monitored properties.

The wellbore 102 may have a casing 104 disposed within, through which production tubing 106 may be deployed as part of a wellbore completion. The DAS system 110 may comprise an acoustic energy source and a DAS device. An active acoustic energy source may generate and emit acoustic signals downhole. For some embodiments, an active acoustic energy source may not be involved in situations where acoustic signals are generated passively (e.g., seismic or microseismic activity). The acoustic signals may interact with the wellbore 102, the wellbore completion, and/or various downhole formations or fluids adjacent the wellbore, leading to transmitted, reflected, refracted, absorbed, and/or dispersed acoustic signals. Measured acoustic signals may have various amplitude, frequency, and phase properties affected by the downhole environment, which may stay constant or change over time. Useful instantaneous, relative changes, time lapse, or accumulated data may be derived from the DAS system 110.

An optical waveguide, such as an optical fiber, within the wellbore 102 may function as the DAS device, measuring disturbances in scattered light that may be propagated within the waveguide (e.g., within the core of an optical fiber). The disturbances in the scattered light may be due to the transmitted, reflected, and/or refracted acoustic signals, wherein these acoustic signals may change the index of refraction of the waveguide or mechanically deform the waveguide such that the optical propagation time or distance, respectively, changes.

The DAS device generally includes employing a single fiber or multiple fibers in the same well and/or multiple wells. For example, multiple fibers may be utilized in different sections of a well, so that acoustic sensing may be performed in the different sections. Sensing may occur at relative levels or stations, immediately adjacent depth levels, or spatially remote depths. The DAS device may involve continuous or periodic dense coiling around a conduit to enhance detection, and coiling the fiber in various physical forms or directions may enhance dimensional fidelity.

The system 110 may have various effective measurement spatial resolutions along the DAS device, depending on the selected pulse widths and optical power of the laser or light source, as well as the acoustic source signature. Therefore, the DAS device may be capable of producing the functional equivalent of tens, hundreds, or even thousands of acoustic sensors along the waveguide, wherein acoustic sensors and/or their functional DAS equivalents may be used for the DAS system 110 in addition to the acoustic source. The bandwidth of the signal that may be measured is typically within the acoustic range (i.e., 20 Hz-20 kHz), but a DAS device may be capable of effectively sensing in the sub-acoustic (i.e., <20 Hz) and ultrasound (i.e., >20 kHz) ranges.

### EXAMPLE DEPLOYMENT OF A DAS SYSTEM

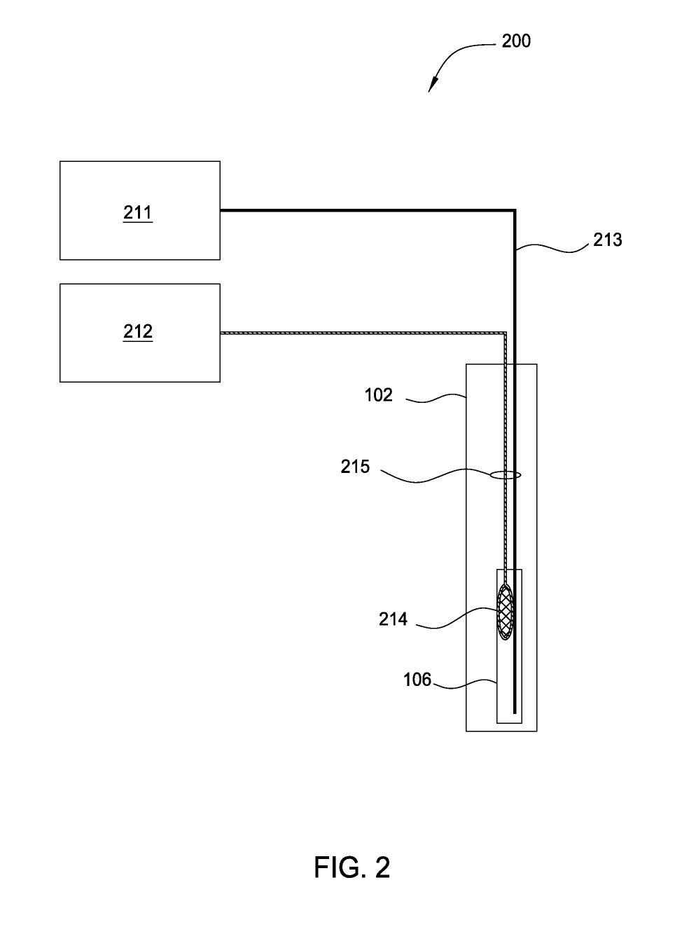

For a DAS system with an acoustic energy source, the location of the acoustic energy source and the DAS device may vary based on the type of acoustic sensing desired. For example, the DAS system may be deployed according to surface deployment geometries or wellbore deployment geometries, as will be further discussed. FIG. 2 illustrates an embodiment of a DAS system 200, comprising an acoustic energy source 214 and a DAS device 213, both suspended in a cable 215 within the wellbore 102, such as within the production tubing 106, as shown. Other examples include a DAS system disposed in items used in the construction of a wellbore. With the acoustic energy source 214 and receiver (DAS device 213) both disposed within the wellbore 102, detailed imaging of formations or conditions in and around a single well is made possible with only the one well access, particularly with the close proximity of the source and receiver.

The DAS system 200 may function as an open hole tool, wherein the wellbore 102 may not have the casing 104 or the tubing 106. Open hole tools may be designed to measure rock properties in the formations surrounding non-cased wellbores, as well as the properties of the fluids contained in the rocks. The DAS system 200 may also function as a cased hole tool (as illustrated), wherein the wellbore 102 may be lined with the casing 104. Cased hole tools may be designed to measure fluid properties within a cased borehole and also to examine the condition of wellbore components, such as the casing 104 or the tubing 106. Cased hole tools may also measure rock and fluid properties through the casing 104.

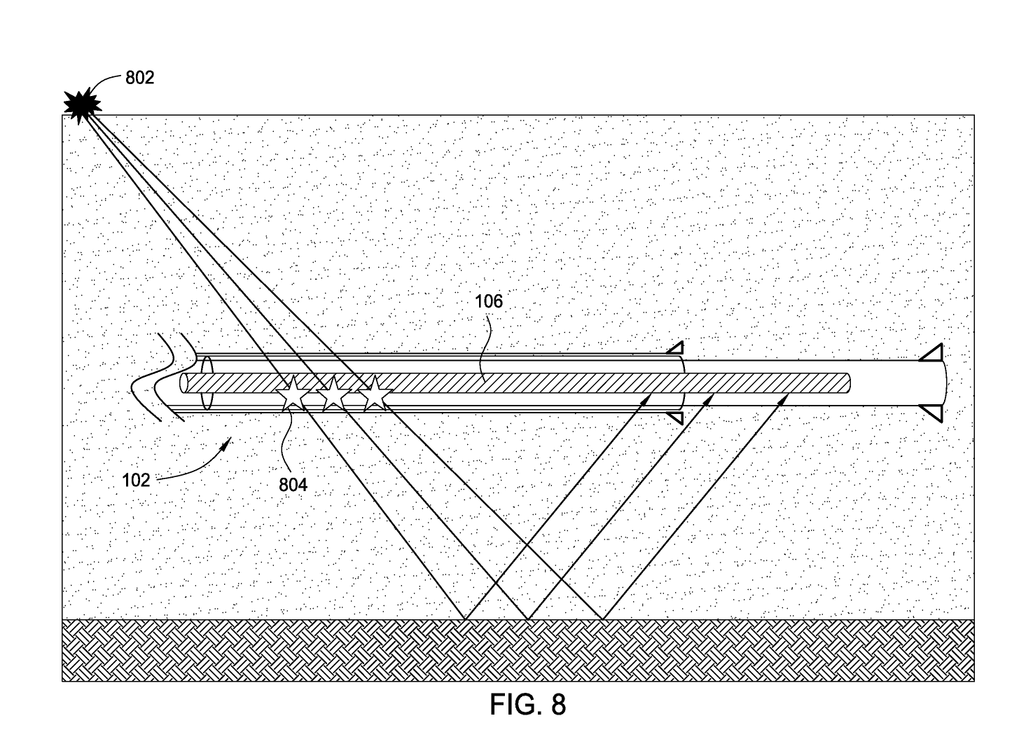

The acoustic energy source 214 may be controlled by an acoustic energy source controller 212, typically disposed at the surface. For example, the controller 212 may transmit electrical pulses in an effort to stimulate piezoelectric or magnetostrictive elements in the acoustic energy source 214, thereby generating the acoustic signals. The controller 212 may manage the pulse width and/or duty cycle of such electrical pulses. Examples of the acoustic energy source generally include a seismic vibrator (e.g., Vibroseis™), an air gun, a sleeve gun, a drop weight, downhole sources of various types (e.g., sparker, howler, piezo-ceramic, and magneto constrictive), or virtual sources (as illustrated in FIG. 8). The acoustic energy source may utilize a swept frequency (e.g., impulsive, coded in time and/or frequency), a mud pulse or fluid column disturbance, and a tube wave (tubing or casing ring). Naturally occurring random or pseudo-random noise, or what would be termed background noise, may also be utilized as an acoustic source. For some embodiments, the acoustic energy source 214 may be a relatively higher acoustic frequency source, such as 20 kHz, for transmission through the earth.

A DAS instrument 211 may introduce an optical pulse, using a pulsed laser, for example, into the DAS device 213. The DAS instrument 211 may also sense the disturbances in the light propagating through the DAS device 213, as described above. For example, the DAS instrument 211 may send an optical signal into the DAS device 213 and may look at the naturally occurring reflections that are scattered back all along the DAS device 213 (i.e., Rayleigh backscatter). By analyzing these reflections and measuring the time between the optical signal being launched and the signal being received, the DAS instrument 211 may be able to measure the effect of the acoustic reflections on the optical signal at all points along the waveguide, limited only by the spatial resolution. Thus, the DAS device 213 may function as the equivalent of tens, hundreds, or thousands of acoustic sensors, depending on the length of the DAS device and the optical pulse width.

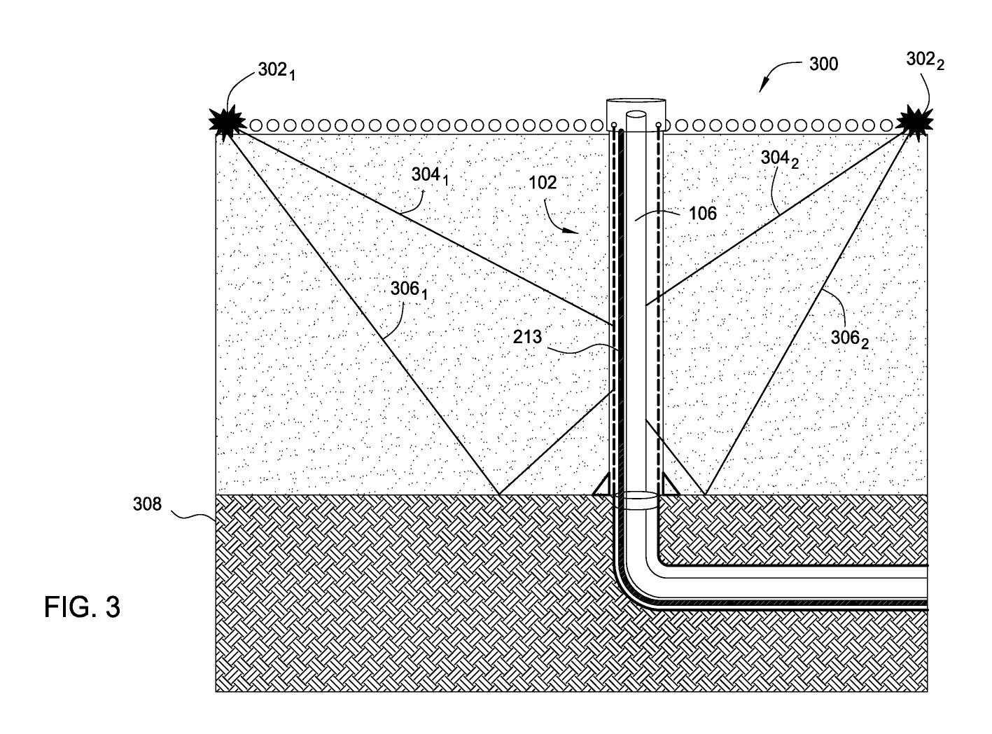

FIG. 3 illustrates an embodiment of a depth conveyancing method utilizing a DAS system 300, comprising acoustic energy sources 302, disposed at the surface of a wellbore 102, and a DAS device 213 suspended in the wellbore 102 along a tubing 106. The surface of the wellbore may be the surface of the Earth on land or under water (e.g., on the sea floor). As illustrated, wellbore 102 may be a non-vertical well, by way of directional drilling.

As described above, the traditional method of acoustic sensing involved the use of an array of one or more acoustic sensors (i.e., multiple discrete devices). With the array of acoustic sensors, acoustic sensing may involve deploying the array along a wellbore and performing acoustic sensing at the discrete locations where the sensors are located. In addition, the array of acoustic sensors may be moved along different areas of the wellbore, to perform acoustic sensing at those particular locations, such that sensing may be performed along the entire length of the wellbore. Therefore, performing acoustic sensing with the array of acoustic sensors may be limited to discrete locations of the sensor, and may be time consuming and cost ineffective.

According to certain embodiments of the present invention, performing acoustic sensing using the DAS device 213 may allow acoustic sensing all along the wellbore 102 without moving the DAS device 213, thereby reducing the time for performing the acoustic sensing, which, in turn, decreases the cost of performing acoustic sensing. For a direct path 304 from one of the sources 302 to a location on the DAS device 213, a velocity may be determined by measuring the amount of time for detection of the emitted signal from the source 302. In addition to the direct path 304, the DAS device 213 may detect reflections 306 of emitted signals from the source 302 and determine a subsurface image. The velocities may be used to determine fluid property parameters, such as porosity and density, and/or an image of the area around the downhole formation 308. Over time, as production continues, these velocities or images may change, providing a time-lapse image of the movement of fluids within the formation 308.

As described above, acoustic signals may be generated passively. For some embodiments, the passive acoustic signals may comprise seismic or microseismic activity in a formation surrounding a conduit. The acoustic signals may interact with a wellbore, the wellbore completion, and/or various downhole formations adjacent the wellbore, leading to transmitted, reflected, refracted, absorbed, and/or dispersed acoustic signals.

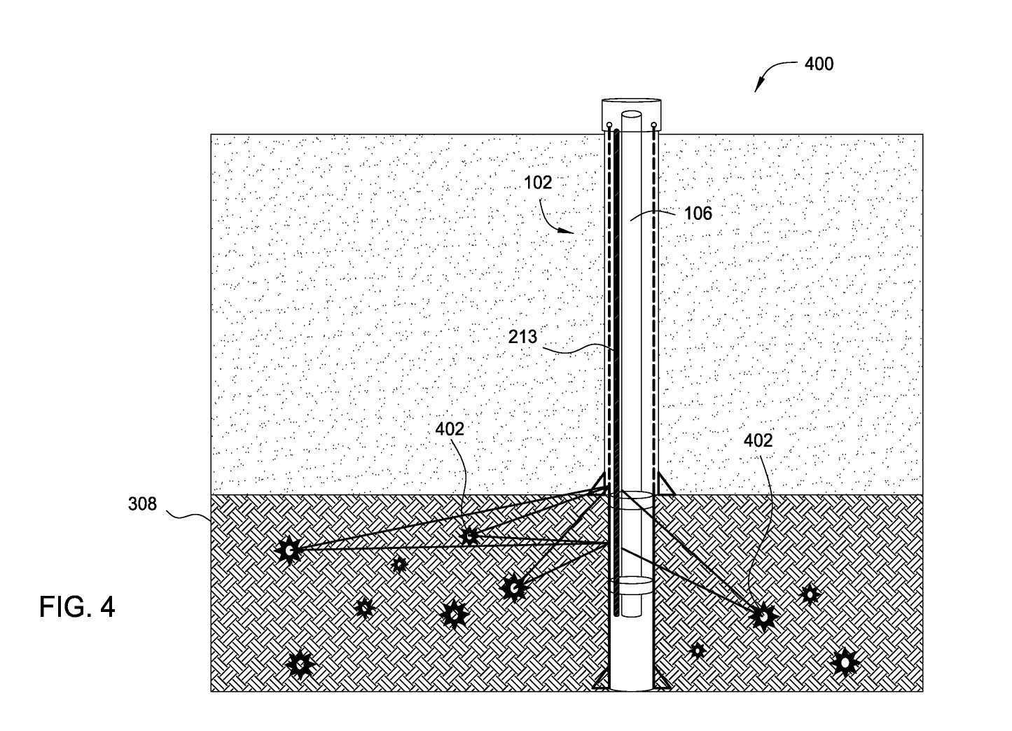

FIG. 4 illustrates an embodiment of a DAS system 400, comprising a DAS device 213 suspended in a wellbore 102 along a tubing 106. As illustrated, rather than the acoustic signals being generated by acoustic energy sources 214, 302, acoustic signals may be generated by microseismic activity 402. As fluid is extracted from the formation 308, layers of the formation 308, that were once supported by the extracted fluid, may shift (e.g., due to a change in pressure), thereby generating the microseismic activity 402 (e.g., naturally occurring fractures caused by formation subsidence or fluid migration). With the traditional method of acoustic sensing involving the use of an array of one or more acoustic sensors, the discrete acoustic sensors may not detect many of the “snaps” produced by the shifting of the layers. However, performing acoustic sensing using the DAS device 213 may allow detection of a greater amount of the microseismic activity 402 produced by the shifting of the layers within the formation 308, due to the myriad of sensing points and the ability to detect the microseismic activity 402 all along the DAS device 213. In other words, when the snaps occurred in time and where they occurred (i.e., physically in three dimensions) may be determined.

Other examples of acoustic signals being generated passively generally include artificially induced microseismic activity, fracturing, general background noises, low frequency emissions from the Earth, turbulent fluid flow, pressures or vibrations and the effects of flow on various downhole jewelry, cross flow between formations, perforations, production or injection flow gas bubbling, and bubble oscillations.

With the ability to detect a greater amount of the microseismic activity 402, the pattern of natural drainage of fluid from the formation 308 may be determined, allowing for further strategic development of the field.

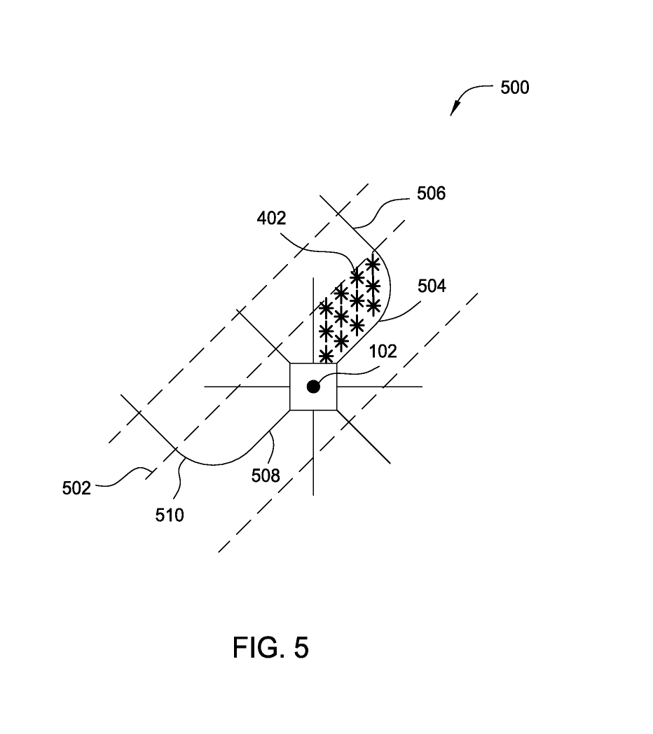

FIG. 5 illustrates a plan view of a wellbore 102 that may be developed further in accordance with the detection of natural or induced subsurface fault lines 502. In a homogeneous formation, horizontal wells may be drilled from the wellbore 102 in a star-pattern fashion. However, with the detection of the fault lines 502 using DAS, deviation from the star pattern may be desired to avoid fractures along the fault lines 502 and reach other areas according to the natural drainage pattern of the formation. As an example, a DAS device disposed along the horizontal well 504 may detect microseismic activity 402, as described above. Detection of the microseismic activity 402 may indicate that the horizontal well 504 is being drilled parallel to the fault line 502. Therefore, the drilling direction of the horizontal well 504 may be changed, as indicated by 506, in an effort to avoid fractures along the fault lines 502 and reach other areas according to the natural drainage pattern of the formation.

As another example, an acoustic energy source and a DAS device may be disposed in a cable within horizontal well 508, similar to that illustrated in FIG. 2. For some embodiments, the acoustic energy source may be an operating drill bit. The acoustic energy source may generate acoustic signals that may be reflected from the fault line 502. The DAS device may detect these reflections and determine that the horizontal well 508 is parallel to the fault line 502. Therefore, the drilling direction of the horizontal well 508 may be changed, as indicated by 510, in an effort to avoid creating fractures along the fault lines 502 and reach other areas according to the natural drainage of fluid from the formation.

As another option for performing acoustic sensing utilizing DAS, an optical waveguide functioning as a DAS device may be deployed on a surface (e.g., on the ground or the seafloor), measuring disturbances in scattered light that may be propagated within the waveguide. As described above, the disturbances in the scattered light may be due to transmitted, reflected, and/or refracted acoustic signals, wherein these acoustic signals may change the index of refraction of the waveguide or mechanically deform the waveguide such that the optical propagation time or distance, respectively, changes.

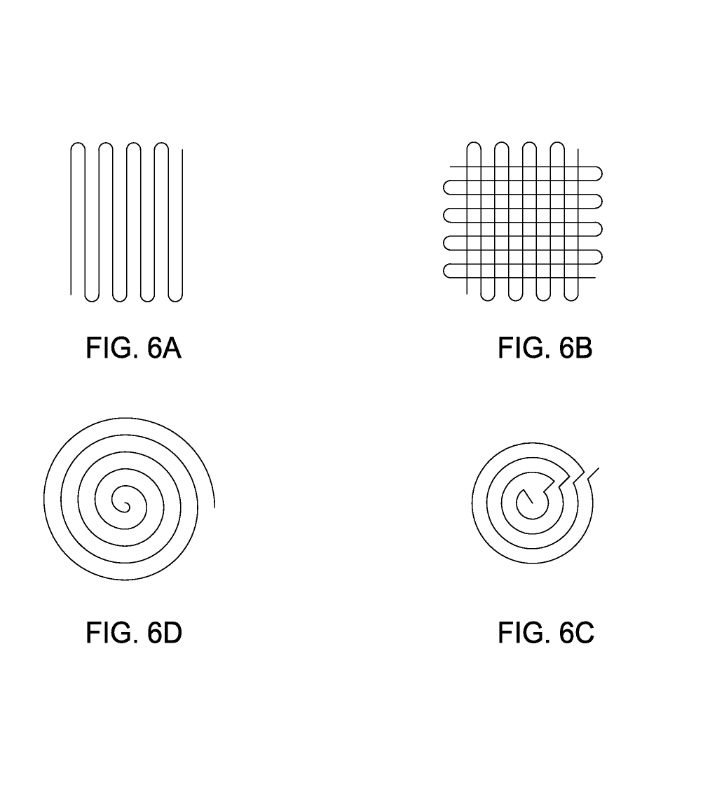

FIGS. 6A-D illustrate examples of surface or relatively shallow subsurface deployment geometries of a DAS device. For example, an optical waveguide, functioning as the DAS device, may be disposed at the surface of the Earth on land or under water (e.g., on the sea floor). FIG. 6A illustrates a surface deployment geometry of a DAS device laid out as a plurality of parallel rows or columns, equally spaced apart and curved on either end such that a single continuous optical waveguide may be used. For some embodiments, the rows or columns of the DAS device may be non-equally spaced (not illustrated). FIG. 6B illustrates multiple optical waveguides that overlay each other to form both rows and columns of a grid or array. For some embodiments, the DAS device may be disposed in this overlaying grid pattern using a single optical waveguide. FIG. 6C illustrates substantially concentric circles, which may be formed using a single optical waveguide. For other embodiments, one or more concentric rings may be formed using a separate optical waveguide. FIG. 6D illustrates a spiral pattern. Other examples of surface deployment geometries generally include linear, star, radial, or cross patterns. For some embodiments, surface deployment of the DAS device may include a combination of the above-described or other various suitable geometries.

For some embodiments, a DAS system may be buried below the surface (e.g., in a trench). The acoustic signals may be generated actively or passively as described above. The DAS system may be deployed according to any of various suitable surface geometries, such as those described above. Multiple fibers, connected fibers, or loops of fibers may be utilized, which may be optically driven from a single end or both ends in this DAS system. The fibers may be attached linearly or may spiral along pipelines or similar structures, above or below surface.

For some embodiments, a DAS system may be deployed in a shallow well (e.g., 50-100 feet), which may function as a test well. The acoustic signals may be generated actively or passively as described above. The DAS system may be deployed according to any of various suitable wellbore geometries, such as those described above. Multiple fibers, connected fibers, or loops of fibers may be utilized, which may be optically driven from a single end or both ends in this DAS system. The DAS system may be deployed on a casing, a tubing, a coiled tubing, or a solid member.

For some embodiments, a DAS system may be deployed at the seabed. The acoustic signals may be generated actively or passively as described above. The DAS system may be deployed according to any of various suitable geometries, such as those described above. Multiple fibers, connected fibers, or loops of fibers may be utilized, which may be optically driven from a single end or both ends in this DAS system.

For some embodiments, a DAS system may be deployed in a deep well. The acoustic signals may be generated actively or passively as described above. The DAS system may be deployed according to any of various suitable wellbore geometries, such as those described above. Multiple fibers, connected fibers, or loops of fibers may be utilized, which may be optically driven from a single end or both ends in this DAS system. The DAS system may be deployed adjacent to wellbore perforations, a production sandface, a sand screen, or other fluid producing areas, for example. The DAS system may be deployed on the seabed to a surface riser (e.g., inside or outside the riser). The DAS system may be deployed inside or outside downhole jewelry. For subsea applications, the DAS system may incorporate the well and the tie back umbilical as a combination, wherein the DAS device may be deployed in the well and the tie back umbilical.

For some embodiments, a DAS system may be deployed in a slimhole well or a microbore. The acoustic signals may be generated actively or passively as described above. The DAS system may be deployed according to any of various suitable wellbore geometries, such as those described above. The slimhole well may be conventionally drilled, and the cable of the DAS system may be attached to a deployment member.

### EXAMPLE APPLICATIONS USING DAS

For some embodiments, a DAS system may allow for seismic surveys. Seismic surveys generally include a single survey type or a combination of survey types. Examples of such seismic surveys may include 1D, 2D, 3D, 4D, time-lapse, surface seismic, Vertical Seismic Profile (VSP) of various common geometries (e.g., zero offset, offset, multi-offset, and walkaway), single well imaging and tomography, cross-well imaging and tomography, and microseismic activity detection in single and multi-wells, as described above.

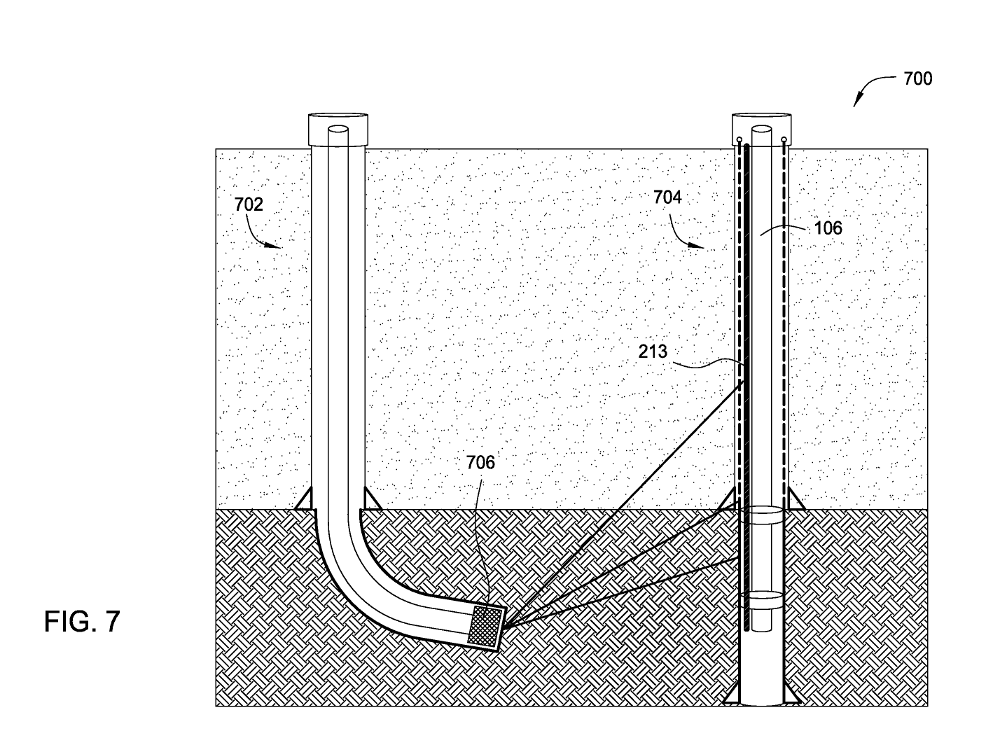

FIG. 7 illustrates an embodiment of a DAS system implementing cross-well imaging. With cross-well imaging, acoustic sensing may be performed between wellbores to gather information about the area between the wellbores. For example, a source from a first wellbore may emit acoustic signals that interact with the area between the wellbores, leading to transmitted, reflected, refracted, and/or absorbed acoustic signals. For some embodiments, the source may be disposed permanently in one or multiple placements along the first wellbore. For some embodiments, the source may be moved along the first wellbore at will. A DAS device disposed along a length of the second wellbore may measure disturbances in scattered light due to the transmitted, reflected, and/or refracted acoustic signals, as described above.

As an example, while drilling wellbore 702 (directional drilling as illustrated), acoustic sensing may be performed between wellbores 702, 704. Acoustic signals may be emitted from the drill bit 706 disposed within wellbore 702, as illustrated. A DAS device 213 disposed along a length of wellbore 704 may receive acoustic signals transmitted through the area between the wellbores, in an effort to determine where to direct or stop the drilling of the wellbore 702. As another example, a DAS device may be disposed along a length of wellbore 702 (not illustrated) and receive acoustic signals originating from the drill bit 706. This information may helpful in determining an area in which to avoid drilling, that may cause a blowout (e.g., due to high pressures). A DAS system implementing cross- well imaging may generally include a plurality of sensing or source wellbores wellbores with either a DAS device or an acoustic energy source), or suitable combinations of multiples of either types of wellbores with suitable relative geometries relative to each other.

FIG. 8 illustrates an embodiment of a DAS system implementing the use of a DAS device (not illustrated) suspended in a wellbore 102 along a tubing 106 as virtual source points 804 for further receivers of subsequent direct or reflected acoustic energies. For example, an acoustic energy source 802 may emit signals. The acoustic signals may interact with the wellbore 102, the wellbore completion, and/or various downhole formations or fluids adjacent the wellbore 102, leading to transmitted, reflected, refracted, absorbed, and/or dispersed acoustic signals. The DAS device may measure disturbances in scattered light that may be propagated within the device, as described above. The location of the disturbances along the DAS device may be considered as the virtual source points 804 for further receivers of subsequent direct or reflected acoustic energies, as illustrated. For some embodiments, a single DAS system may be used as both a virtual source and actual receiver system in the same well.

Further applications of a DAS system generally include detecting wellbore events, carbon dioxide (CO₂) plume tracking, gas storage, reservoir fluid movement, fluid flow pattern, reservoir drainage pattern (as illustrated in FIG. 5), bypassed pay, injection gas breakthrough, condensate dropout from critical fluid, flood front tracking (e.g., steam, fire, CO₂, water, nitrogen, and water alternating gas (WAG)), noise level or impulsive event step change, fluid identification, seismic while drilling (e.g., from near surface casing), perforation performance, fluid contrast interface monitoring (e.g., gas-oil contact (GOC) and oil-water contact (OWC)), sand production detection, gas leakage behind casing or vertical fracture (e.g., gas migration), relative permeability, Deep Earthquake monitoring, fault/fracture re-activation warning, geothermal generation (e.g., hot dry rock), virtual source origin, salt flank proximity, salt dome exit, identification of multiples and velocity changes in depth leading to correction of 4D surface seismic error due to change in multiples due to compaction over time, flow control optimization, parallel wellbore proximity, and nuclear waste repository analysis of rock and crack development through natural processes like water movement or saturation and also earth tremors.

For some embodiments, a DAS system may allow for vibration surveys. Such vibration surveys generally include determination of life expectancy, fatigue life, perimeter safety, structural frequency response to flow-induced loading (e.g., buffeting), lift optimization, pump monitoring, resonance monitoring, and tubing movement.

For some embodiments, a DAS system may allow for a combination of the above-described surveys (i.e., seismic and vibration). For example, the DAS system may allow for comparing acoustically opaque and transparent images, passive and active image combination, combined (e.g., acoustic, electrical, nuclear, temperature, pressure, and/or flow) measurements, natural corrosion or galvanic protection, or other distributed electrical field detection.

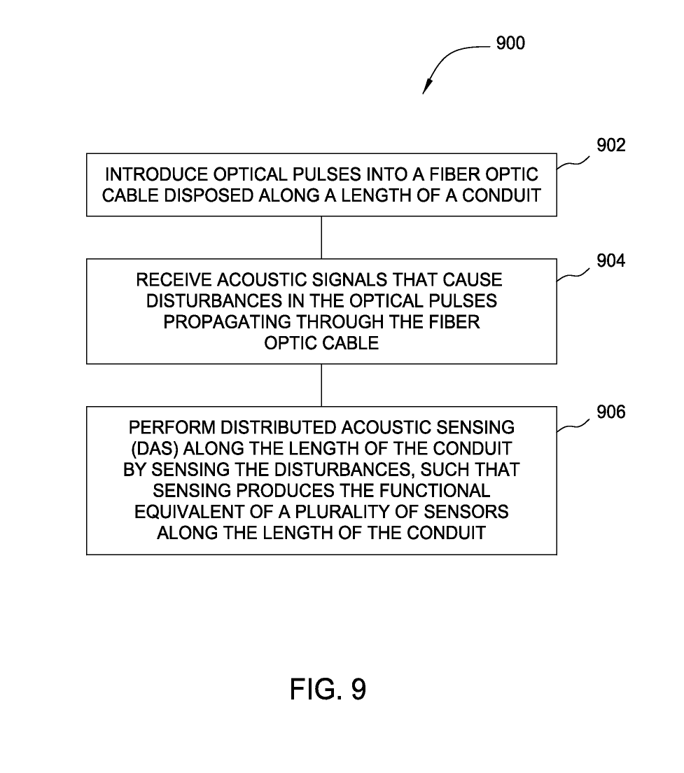

FIG. 9 illustrates example operations 900 for performing DAS along a length of a conduit, according to embodiments of the present invention. The operations may begin at 902 by introducing optical pulses (e.g., laser light pulses) into a fiber optic cable disposed along the length of the conduit.

At 904, the fiber optic cable may receive acoustic signals that cause disturbances in the optical pulses propagating through the fiber optic cable. For some embodiments, the acoustic signals may be generated from a passive source, wherein the passive source generally includes seismic or micro-seismic activity in a formation adjacent the conduit. For some embodiments, the acoustic signals may be generated from an active acoustic energy source, wherein the active source may produce acoustic stimulation along at least a portion of the length of the conduit.

The acoustic signals may interact with at least one of a wellbore, a wellbore completion, or a formation adjacent the conduit to form transmitted, reflected, refracted, or absorbed acoustic signals and wherein the transmitted, reflected, or refracted acoustic signals may cause the disturbances in the optical pulses propagating through the fiber optic cable. For some embodiments, the acoustic signals may change an index of refraction or mechanically deform the fiber optic cable such that a Rayleigh scattered signal changes.

At 906, DAS may be performed along the length of the conduit by sensing the disturbances, such that the sensing produces the functional equivalent of a plurality of sensors along the length of the conduit. The plurality of sensors may comprise at least tens, hundreds, or thousands of sensors.

While the foregoing is directed to embodiments of the present invention, other and further embodiments of the invention may be devised without departing from the basic scope thereof, and the scope thereof is determined by the claims that follow.

1. A method, comprising:
introducing optical pulses into a fiber optic cable disposed along a length of a conduit;
receiving acoustic signals that cause disturbances in the optical pulses propagating through the fiber optic cable; and
performing distributed acoustic sensing (DAS) along the length of the conduit by sensing the disturbances, such that the sensing produces the functional equivalent of a plurality of sensors along the length of the conduit.

2. The method of claim 1, wherein the plurality of sensors comprise at least tens, hundreds, or thousands of sensors.

3. The method of claim 1, wherein the acoustic signals are generated from a passive source.

4. The method of claim 3, wherein the passive source comprises seismic or micro-seismic activity in a formation adjacent the conduit.

5. The method of claim 1, further comprising:
generating the acoustic signals via an acoustic energy source, wherein the acoustic energy source produces acoustic stimulation along at least a portion of the length of the conduit.

6. The method of claim 5, wherein the acoustic energy source comprises an operating drill bit.

7. The method of claim 5, wherein the acoustic signals interact with at least one of a wellbore, a wellbore completion, or a formation adjacent the conduit to form transmitted, reflected, refracted, or absorbed acoustic signals and wherein the transmitted, reflected, or refracted acoustic signals cause the disturbances in the optical pulses propagating through the fiber optic cable.

8. The method of claim 1, wherein the acoustic signals may change an index of refraction or mechanically deform the fiber optic cable such that a Rayleigh scattered signal changes.

9. The method of claim 1, wherein the conduit comprises one of a surface pipeline, a well casing, or production tubing.

10. The method of claim 1, further comprising:
detecting one or more faults based upon the DAS; and
drilling in a different direction based on the detection.

11. The method of claim 1, wherein the fiber optic cable is disposed along the length of the conduit in at least one of equally spaced rows or columns, non-equally spaced rows or columns, a grid, substantially concentric circles, a spiral pattern, a linear pattern, or a star pattern.

12. A system, comprising:
a fiber optic cable disposed along a length of a first wellbore;
an acoustic energy source disposed in a second wellbore for generating acoustic signals; and
a control unit for performing distributed acoustic sensing (DAS) along the length of the first wellbore, wherein the control unit is configured to:
introduce optical pulses into the fiber optic cable, wherein the acoustic signals cause disturbances in the optical pulses propagating through the fiber optic cable; and
perform the DAS, such that the sensing produces the functional equivalent of a plurality of sensors along the length of the first wellbore.

13. The system of claim 12, wherein the plurality of sensors comprise at least tens, hundreds, or thousands of sensors.

14. The system of claim 12, wherein the acoustic signals interact with a formation adjacent the first and second wellbores to form transmitted, reflected, refracted, or absorbed acoustic signals and wherein the transmitted, reflected, or refracted acoustic signals cause the disturbances in the optical pulses propagating through the fiber optic cable.

15. The system of claim 12, wherein the acoustic signals may change an index of refraction or mechanically deform the fiber optic cable such that a Rayleigh scattered signal changes.

16. The system of claim 12, wherein the acoustic energy source comprises a rotating drill bit operating in the second wellbore.

17. A system, comprising:
a fiber optic cable disposed at a surface of a wellbore; and
a control unit for performing distributed acoustic sensing (DAS) at the surface of the wellbore, wherein the control unit is configured to:
introduce optical pulses into the fiber optic cable, wherein acoustic signals cause disturbances in the optical pulses propagating through the fiber optic cable; and
perform the DAS, such that the sensing produces the functional equivalent of a plurality of sensors at the surface of the wellbore.

18. The system of claim 17, further comprising an active acoustic energy source for generating the acoustic signals adjacent the wellbore.

19. The system of claim 17, wherein the fiber optic cable is disposed at the surface of the wellbore in at least one of equally spaced rows or columns, non-equally spaced rows or columns, a grid, substantially concentric circles, a spiral pattern, a linear pattern, or a star pattern.

20. The system of claim 17, wherein the fiber optic cable is disposed at a surface of the Earth under water.
